(19) United States
(12) Patent Application Publication
(10) Pub. No.: US 2020/0218716 A1
(43) Pub. Date: Jul. 9, 2020

(54) MIDDLEWARE SERVER AND METHOD FOR PROCESSING DATA THEREOF

(71) Applicant: FOURSTEC INC., Incheon (KR)

(72) Inventors: Seung Won LEE, Incheon (KR); Byeong Gweon KIM, Bucheon-si, Gyeonggi-do (KR)

(73) Assignee: FOURSTEC INC., Incheon (KR)

(21) Appl. No.: 16/648,160

(22) PCT Filed: Mar. 2, 2018
(86) PCT No.: PCT/KR2018/002540

§ 371 Date: Mar. 17, 2020

(30) Foreign Application Priority Data
Sep. 27, 2017 (KR) 10-2017-0124949

(51) Int. Cl. G06F 16/245; G06K 7/10; H04L 29/06

(52) U.S. Cl. CPC G06F 16/245; H04L 63/12; G06K 7/10366

(57) ABSTRACT

A middleware server includes: a proxy unit which receives first data attribute information, first communication terminal location attribute information, and first collection data from each first communication terminal using an RFID communication scheme, and receives second data attribute information, second communication terminal location attribute information, and second collection data from each second communication terminal using a communication scheme other than RFID; a data processing rule selection module which selects a data processing rule for processing the first collection data on the basis of the received first data attribute information and first communication terminal location attribute information, and selects a data processing rule for processing the second collection data on the basis of the received second data attribute information and second communication terminal location attribute information; and a data processing module which respectively processes the first collection data and the second collection data, according to the selected data processing rule.

### CROSS REFERENCE TO PRIOR APPLICATIONS

This application is a National Stage Patent Application of PCT International Patent Application No. PCT/KR2018/002540 (filed on Mar. 2, 2018) under 35 U.S.C. § 371, which claims priority to Korean Patent Application No. 10-2017-0124949 (filed on Sep. 27, 2017), which are all hereby incorporated by reference in their entirety.

### BACKGROUND

The present disclosure relates to a middleware server and a method of processing data thereof, and more particularly, to a middleware server and a method of processing data thereof capable of receiving data attribute information, communication terminal location attribute information, and collected data from each of first communication terminals using an RFID communication method and second communication terminals using a communication method other than RFID to process the collected data according to an optimized data processing rule.

Objects having conceptual extension of RFID/USN standard technology and sensors, drivers, and situation recognition functions provide connectivity between people and objects, and objects and objects through various network technologies and communicate with each other and provide an intelligent service by combining situation recognition based knowledge.

An IoT service that can support and smoothly integrate the global concept of such Internet of Things (IoT) has not yet appeared. This is because the Internet of Things has various national, industrial, social, and personal interests, policies and security issues in addition to technical problems.

Further, there is a need for proliferation of intelligent sensor services in which anyone may install, access, develop, and use by easily using without consciousness of vast USN technology/infrastructure that has been built so far.

Current converged IoT middleware requires a separate operating program for each hardware device and separate customization. That is, the current IoT software (SW) should install and customize separately RFID, NFC, barcode, BLE, beacon, GPS, temperature sensor, humidity sensor, motion sensor, weight sensor (weight bridge), vehicle number recognition (LPR), camera recognition (OCR), LED, wearable equipment, and smart device operation program.

A maintenance and management cost of an SI main system, which is the existing IoT SW, is increasing due to the operation of each program. That is, a management target and management cost are increasing due to separation of IoT SW (individual program). Further, because the software is developed individually, installation and management costs are high. Further, the software is vulnerable to flexible interworking with smart devices.

When three or more IoT sensing devices (barcode, Bluetooth, GPS, temperature/humidity/motion/weight sensor, license plate and camera recognition, wearable device, smart device, etc.) are converged, a performance thereof is limited by the introduction of a high performance server system. That is, in order to use each IoT sensing device, expensive software should be developed. Further, the use of a high performance server system is constrained by a performance of hardware in the operation of middleware and related applied program.

In other words, when building an IoT environment through various sensing devices (barcode, RFID, NFC, BLE, beacon, GPS, temperature sensor, humidity sensor, motion sensor, weight sensor (weight bridge), license plate recognition (LPR), camera recognition (OCR), LED, wearable device, smart device, etc.) used in the Internet of Things, the IoT environment is connected to an operation platform through middleware according to each device. In this case, importance of a function of the middleware according to diversification and mass production of the equipment has been highlighted.

### SUMMARY

The present disclosure relates to a middleware server and a method of processing data thereof, and more particularly, to a middleware server and a method of processing data thereof capable of receiving data attribute information, communication terminal location attribute information, and collected data from each of first communication terminals using an RFID communication method and second communication terminals using a communication method other than RFID to process the collected data according to an optimized data processing rule.

In an aspect, there is provided a middleware server including a proxy unit for receiving first data attribute information, first communication terminal location attribute information, and first collection data from each of first communication terminals using an RFID communication method and receiving second data attribute information, second communication terminal location attribute information, and second collection data from each of second communication terminals using a communication method other than RFID; a data processing rule selection module for selecting a data processing rule for processing the first collection data based on the received first data attribute information and first communication terminal location attribute information and selecting a data processing rule for processing the second collection data based on the received second data attribute information and second communication terminal location attribute information; and a data processing module for processing each of the first collection data and the second collection data according to the selected data processing rules.

The proxy unit may include a first proxy for receiving the first data attribute information, the first communication terminal location attribute information, and the first collection data from each of the first communication terminals; and a second proxy for receiving the second data attribute information, the second communication terminal location attribute information, and the second collection data from each of the second communication terminals, separately from the first proxy.

The middleware server may further include a security module for decoding the second data attribute information, the second communication terminal location attribute information, and the second collection data collected through the second proxy.

The data processing rule selection module may select a data processing rule of the first collection data and a data processing rule of the second collection data according to different criteria.

The middleware server may further include a data processing rule updater for receiving processed results of data processed by the data processing module to be transmitted to the main server from the main server and updating the data processing rules according to the received processing result.

The data processing module may include a data reception module for receiving the first collection data transmitted through the first proxy and the second collection data transmitted through the security module; a log management module for recording and managing a log of the first collection data and the second collection data received by the data reception module; and a data processing unit for receiving the first collection data and the second collection data transmitted through the data reception module and processing each of the received first collection data and second collection data according to the data processing rule transmitted from the data processing rule selection module.

The data processing unit may include a data pattern analysis module for determining whether a particular data pattern is included in the first collection data or the second collection data.

The data processing unit may include an input number counter for counting the number of times in which the first collection data or the second collection data is input during a reference time.

The data processing rule selection module may include a processing rule selection module for selecting a plurality of data processing rules for processing the first data collection based on the received first data attribute information and first communication terminal location attribute information and selecting a plurality of data processing rules for processing the second collection data based on the received second data attribute information and second communication terminal location attribute information; a processing rule priority determination module for determining an application priority of the selected data processing rules; and a processing rule combination module for combining the selected data processing rules to transmit the combined data processing rules to the data processing module according to the determined priority.

In another aspect, there is provided a method of processing data of a middleware server including receiving first data attribute information, first communication terminal location attribute information, and first collection data from each of first communication terminals using a RFID communication method; receiving second data attribute information, second communication terminal location attribute information, and second collection data from each of second communication terminals using a communication method other than RFID; selecting a data processing rule for processing the first collection data based on the received first data attribute information and first communication terminal location attribute information and selecting a data processing rule for processing the second collection data based on the received second data attribute information and second communication terminal location attribute information; and processing each of the first collection data and the second collection data according to the selected data processing rules.

### BRIEF DESCRIPTION OF THE DRAWINGS

In order to better understand the drawings cited in the detailed description of the invention, a brief description of each drawing is provided.

FIG. 1 is a conceptual diagram of a communication system according to an embodiment of the present disclosure.

FIG. 2 is a block diagram according to one embodiment of the communication system illustrated in FIG. 1;

FIG. 3 is a block diagram according to one embodiment of a data processing rule selection module illustrated in FIG. 2.

FIG. 4 is a block diagram according to one embodiment of a data processing module illustrated in FIG. 2.

FIG. 5 is a flowchart illustrating a method of processing data of a middleware server according to one embodiment of the present disclosure.

### DETAILED DESCRIPTION

The present disclosure may be variously modified and have various embodiments. Specific embodiments are illustrated in the drawings and described in detail through the detailed description. However, this is not intended to limit the technical spirit of the present disclosure to specific embodiments, it should be understood to include all modifications, equivalents, and substitutes included in the scope of the technical spirit of the present disclosure.

In describing the technical spirit of the present disclosure, when it is determined that the detailed description of the related known technology may unnecessarily obscure the gist of the present disclosure, the detailed description thereof will be omitted. Further, the numbers (e.g., first, second, etc.) used in the description process of the present specification are merely identification symbols for distinguishing one component from another component.

Further, in the present specification, when it is described that one component is “connected” or “accessed” to another component, the one component may be directly connected to or directly accessed to the other component, but it should be understood that unless explicitly described to the contrary, the element may be connected to the other element or accessed to the other element through a third element.

Further, terms such as “˜unit”, “˜device”, “˜part”, “˜module” described in the present specification mean a unit for processing at least one function or operation, which may be implemented in hardware or software, or a combination of hardware and software such as a processor, a microprocessor, a micro controller, a central processing unit (CPU), a graphics processing unit (GPU), an accelerate processor unit (APU), a digital signal processor (DSP), an application specific integrated circuit (ASIC), and a field programmable gate array (Field) and may be implemented in a form combined with a memory that stores data necessary for processing at least one function or operation.

It is intended to clarify that the division of the components in the present specification is only divided by the main function of each component. That is, two or more components to be described hereinafter may be combined into one component, or one component may be provided with divided into two or more for each of more detailed functions. Each of the components to be described hereinafter may additionally perform some or all of the functions of other components in addition to the main functions thereof, and some of the main functions of each of the components may be carried out exclusively by other components.

Hereinafter, embodiments according to the technical spirit of the present disclosure will be described in detail.

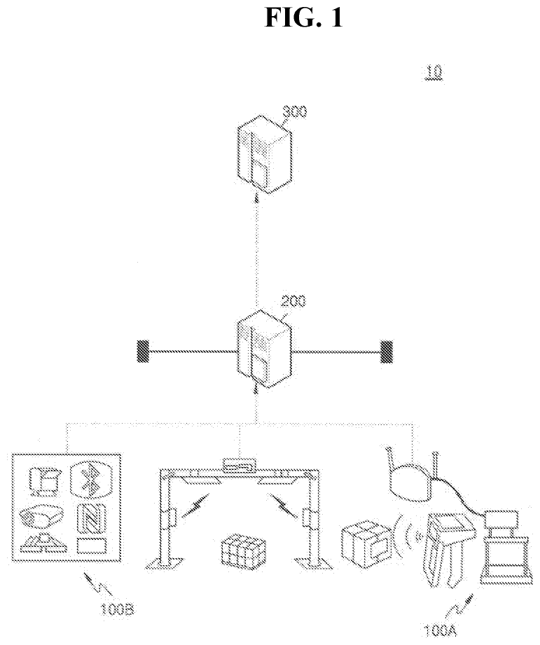

FIG. 1 is a conceptual diagram of a communication system according to an embodiment of the present disclosure.

Referring to FIG. 1, a communication system 10 may include first communication terminals 100A, second communication terminals 100B, a middleware server 200, and a main server 300.

Each of the first communication terminals 100A may communicate using an RFID communication method and collect data from an RFID tag attached to a target object to transmit the collected data to the middleware server 200.

Each of the second communication terminals 100B may communicate using a communication method other than RFID, for example, various communication methods such as Bluetooth and WiFi and collect various kinds of sensing data such as barcode information, GPS information, environmental sensing information (temperature, humidity, etc.), moving information, and image information to transmit the collected data to the middleware server 200.

According to an embodiment, each of the second communication terminals 100B may be referred to as various terms such as an Internet of Things (IoT) device, an Internet of Everything (IoE) device, a Machine to Machine (M2M) device, and a Ubiquitous Sensor Network (USN) device.

The middleware server 200 may receive data attribute information, communication terminal location attribute information, and collected data from each of the first communication terminals 100A and the second communication terminals 100B.

The middleware server 200 may select a data processing rule based on the data attribute information and the communication terminal location attribute information and process collected data received from each of the first communication terminals 100A and the second communication terminals 100B according to the selected data processing rule.

In the present specification, “collected data” may broadly mean data in which each of the first communication terminals 100A and the second communication terminals 100B has or data collected through various forms (e.g., scanning, capturing, sensing).

In the present specification, “data attribute information” may broadly mean an attribute of information included in collected data. According to an embodiment, “data attribute information” may include attributes of various information such as a temperature, humidity, a movement, or a vibration.

In the present specification, “communication terminal location attribute information” may broadly mean information about an attribute of a location in which a communication terminal collecting collected data is located.

According to an embodiment, “communication terminal location attribute information” may include various location attributes such as a high temperature region, a high humid region, or a high noise region.

According to an embodiment, “communication terminal location attribute information” may be defined as a location area.

According to an embodiment, locations of each of the first communication terminals 100A and the second communication terminals 100B may be moved, and in this case, each of the first communication terminals 100A and the second communication terminals 100B may include a positioning module for positioning a location thereof. Further, communication terminal location attribute information of the first communication terminals 100A and the second communication terminals 100B may be changed based on positioning information that varies according to a changing location.

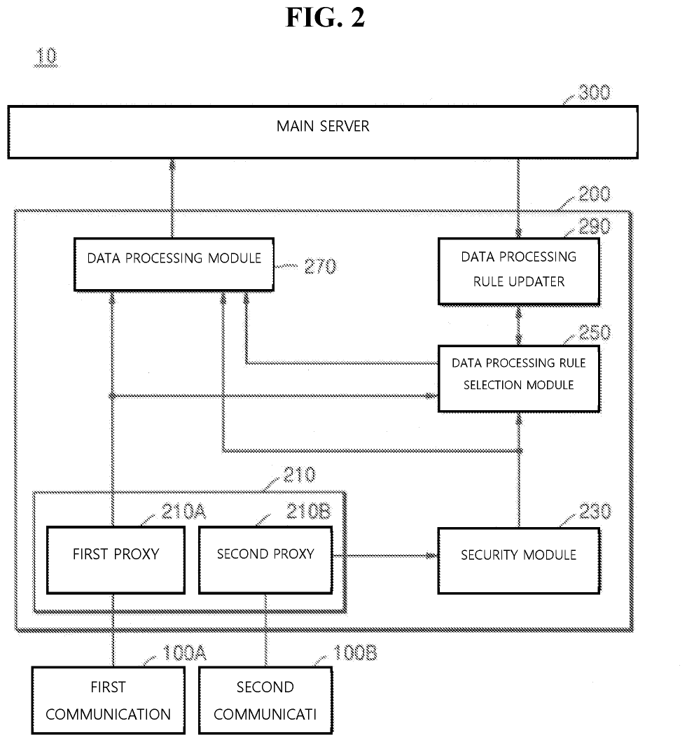

A detailed structure and operation of the middleware server 200 will be described later with reference to FIGS. 2 to 5.

The middleware server 200 may transmit the processed collected data to the main server 300.

The main server 300 may provide various services using collected data collected from each of the first communication terminals 100A and the second communication terminals 100B to be processed by the middleware server 200.

According to an embodiment, when the communication system 10 is implemented into a smart factory, the main server 300 may monitor operation situations of various devices and apparatuses operating in a factory using collected data or may autonomously control various devices and apparatuses based on the collected data.

FIG. 2 is a block diagram according to one embodiment of the communication system illustrated in FIG. 1.

In FIG. 2, for convenience of description, it is illustrated that the middleware server 200 receives collected data from one first communication terminal 100A and one second communication terminal 100B, but the number of the first communication terminal 100A and the number of the second communication terminal 100B may vary and thus the technical scope of the present disclosure should not be limited.

Referring to FIGS. 1 and 2, the middleware server 200 may include a proxy unit 210, a security module 230, a data processing rule selection module 250, a data processing module 270, and a data processing rule updater 290.

The proxy unit 210 may include a first proxy 210A and a second proxy 210B.

The first proxy 210A may receive first data attribute information, first communication terminal location attribute information, and first collection data from the first communication terminal 100A.

The first proxy 210A may transmit the first data attribute information and the first communication terminal location attribute information to the data processing rule selection module 250 and transmit the first collection data to the data processing module 270.

The second proxy 210B may receive second data attribute information, second communication terminal location attribute information, and second collection data from the second communication terminal 100B.

According to an embodiment, the second data attribute information, the second communication terminal location attribute information, and the second collection data may be transmitted to the second proxy 210B in an encrypted state from the second communication terminal 100B.

In this case, the second proxy 210B may transmit the second data attribute information, the second communication terminal location attribute information, and the second collection data to the security module 230.

According to another embodiment, the second data attribute information, the second communication terminal location attribute information, and the second collection data may be transmitted to the second proxy 210B without being encrypted.

In this case, the middleware server 200 may be implemented in a form not including the security module 230, and the second proxy 210B may transmit the second data attribute information and the second communication terminal location attribute information to the data processing rule selection module 250 and transmit the second collection data to the data processing module 270.

According to an embodiment, when the proxy unit 210 is configured with an integrated proxy, the proxy unit 210 may further include a switching module (not shown) for switching a data processing path according to whether information or data is collected from one of the first communication terminal 100A and the second communication terminal 100B.

The security module 230 may decode the second data attribute information, the second communication terminal location attribute information, and the second collection data transmitted from the second proxy 210B.

According to an embodiment, the security module 230 may extract identification information for identifying the second communication terminal 100B collecting the second collection data from the second collection data and obtain algorithm or a decryption key to be used for decoding based on the extracted identification information.

The security module 230 may transmit the decoded second data attribute information and the second communication terminal location attribute information to the data processing rule selection module 250 and transmit the decoded second collection data to the data processing module 270.

The data processing rule selection module 250 may select a data processing rule for processing first collection data based on the first data attribute information and the first communication terminal location attribute information, and select a data processing rule for processing second collection data based on the second data attribute information and the second communication terminal.

According to an embodiment, the data processing rule selection module 250 may select a data processing rule for processing the first collection data and a data processing rule for processing the second collection data according to different criteria.

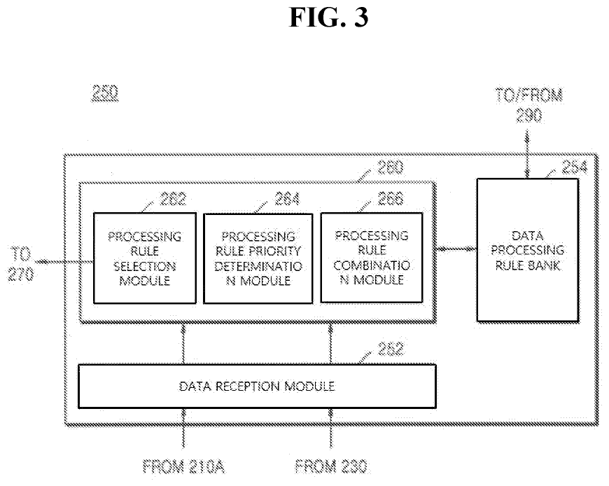

A detailed structure and operation of the data processing rule selection module 250 will be described later with reference to FIG. 3.

The data processing module 270 may process each of the first collection data and the second collection data according to the data processing rule selected by the data processing rule selection module 250. In this case, the data processing module 270 may process each of the first collection data and the second collection data in different ways according to the selected data processing rule.

The data processing module 270 may transmit the processed first collection data and the processed second collection data to the main server 300.

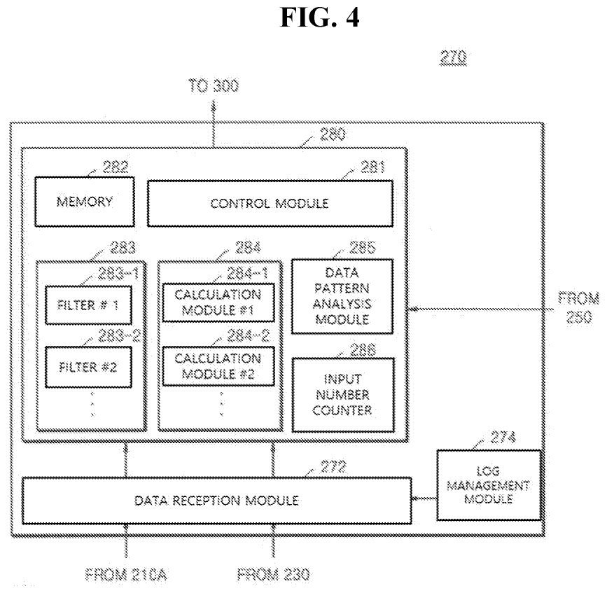

A detailed structure and operation of the data processing module 270 will be described later with reference to FIG. 4.

The data processing rule updater 290 may receive a processing result of data processed by the data processing module 270 and transmitted to the main server 300 from the main server 300, and update the data processing rule according to the received processing result.

According to an embodiment, the processing result transmitted from the main server 300 to the data processing rule updater 290 may include information about errors or overloads generated by the first collection data and second collection data transmitted from the data processing module 270 to the main server 300.

FIG. 3 is a block diagram according to one embodiment of a data processing rule selection module illustrated in FIG. 2.

Referring to FIGS. 2 and 3, the data processing rule selection module 250 may include a data reception module 252, a data processing rule bank 254, and a data processing criterion determination unit 260.

The data reception module 252 may receive first data attribute information and first communication terminal location attribute information transmitted from the first proxy 210A, and receive second data attribute information and second communication terminal location attribute information transmitted from the security module 230.

The data reception module 252 may transmit each of the first data attribute information and the first communication terminal location attribute information, the second data attribute information, and the second communication terminal location attribute information to the data processing reference determination unit 260.

The data processing rule bank 254 may map and store data processing rules corresponding to the first data attribute information and the first communication terminal location attribute information, and separately map and store data processing rules corresponding to the second data attribute information and the second communication terminal location attribute information.

According to an embodiment, the data processing rule bank 254 may define data processing rules in order to process differently first collection data and second collection data, even if the first data attribute information and the second data attribute information are the same and the first communication terminal location attribute information and the second communication terminal location attribute information are the same.

The mapping relationship of the data processing rules stored in the data processing rule bank 254 may be changed according to the update contents of the data processing rule updater 290.

The data processing criterion determination unit 260 may include a processing rule selection module 262, a processing rule priority determination module 264, and a processing rule combination module 266.

The processing rule selection module 262 may select a data processing rule for processing the first collection data based on the first data attribute information and the first communication terminal location attribute information.

According to an embodiment, the processing rule selection module 262 may select a plurality of data processing rules for processing the first collection data based on the first data attribute information and the first communication terminal location attribute information.

The processing rule selection module 262 may select a data processing rule for processing the second collection data based on the second data attribute information and the second communication terminal location attribute information.

According to an embodiment, the processing rule selection module 262 may select a plurality of data processing rules for processing the second collection data based on the second data attribute information and the second communication terminal location attribute information.

When a plurality of data processing rules are selected for at least one collection data among the first collection data and the second collection data by the processing rule selection module 262, the processing rule priority determination module 264 and the processing rule combination module 266 may further operate.

The processing rule priority determination module 264 may determine an application priority of the plurality of selected data processing rules.

The processing rule combination module 266 may combine the data processing rules according to the priority determined by the processing rule priority determination module 264.

According to an embodiment, the processing rule combination module 266 may determine the application order of the plurality of selected data processing rules and combine the data processing rules according to the determined order.

According to another embodiment, the processing rule combination module 266 may select only one data processing rule having a high priority according to an application priority among the plurality of selected data processing rules.

The data processing criterion determination unit 260 may transmit the determined data processing criteria to the data processing module 270.

FIG. 4 is a block diagram according to one embodiment of a data processing module illustrated in FIG. 2.

Referring to FIGS. 2 to 4, the data processing module 270 may include a data reception module 272, a log management module 274, and a data processing unit 280.

The data reception module 272 may receive first collection data transmitted through the first proxy 210A and second collection data transmitted after being decoded by the security module 230.

The data reception module 272 may transmit the received first collection data and second collection data to the log management module 274 and the data processing unit 280.

The log management module 274 may sequentially store the first collection data and the second collection data transmitted from the data reception module 272 and record and manage a log of the stored first collection data and second collection data.

The data processing unit 280 may process the first collection data transmitted through the data reception module 272 according to the data processing rule transmitted from the data processing rule selection module 250 and process the second collection data according to the data processing rule transmitted from the data processing rule selection module 250.

The data processing unit 280 may include a control module 281, a memory 282, a filter unit 283, a calculator 284, a data pattern analysis module 285, and an input number counter 286.

The control module 281 may control the overall operation of the data processing unit 280. The control module 281 may select and control modules or units necessary for data processing according to the data processing rules transmitted from the data processing rule selection module 250.

The memory 282 may store or temporarily store required data in a data processing process of the data processing unit 280.

The filter unit 283 may include various forms of filters 283-1, 283-2, . . . .

According to an embodiment, the filter unit 283 may include a filter for extracting data of a specific numerical range or filtering out data of a specific numerical range.

A calculation unit 284-1 may include a plurality of calculation modules 284-1, 284-2, . . . .

According to an embodiment, the calculation unit 284-1 may include a calculation module for calculating a change amount of the collected data, a calculation module for calculating a change rate of the collected data, and a calculation module for calculating an average value or a median value in a specific section of the collected data.

The data pattern analysis module 285 may determine whether a specific data pattern is included in the collected data.

According to an embodiment, the data pattern analysis module 285 may determine similarity between collected data and a specific data pattern.

The input number counter 286 may count the number of times in which the collected data is input during a reference time.

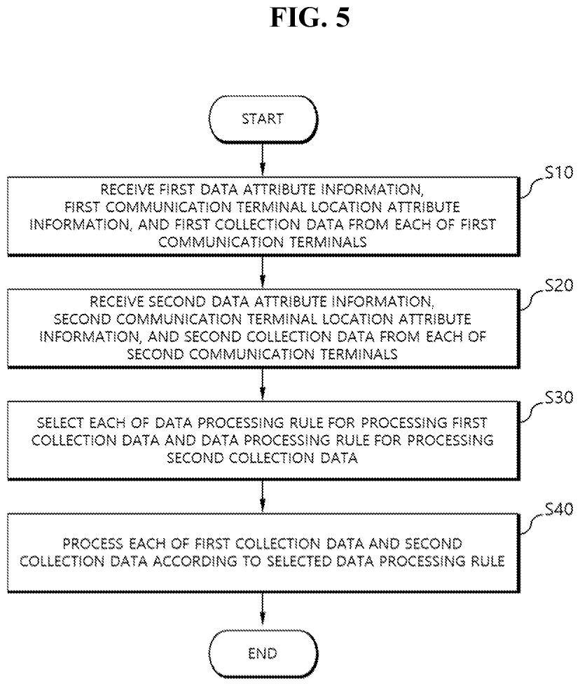

FIG. 5 is a flowchart illustrating a method of processing data of a middleware server according to one embodiment of the present disclosure.

Referring to FIGS. 1 to 5, the middleware server 200 may receive first data attribute information, first communication terminal location attribute information, and first collection data from each of the first communication terminals 100A using an RFID communication method (S10).

Further, the middleware server 200 may receive second data attribute information, second communication terminal location attribute information, and second collection data from each of the second communication terminals 100B using a communication method other than RFID (S20).

The middleware server 200 may select a data processing rule for processing the first collection data based on the first data attribute information and the first communication terminal location attribute information, and select a data processing rule for processing the second collection data based on the second data attribute information and the second communication terminal location attribute information (S30).

The middleware server 200 may process each of the first collection data and the second collection data according to the selected data processing rule (S40) and transmit each of the processed first collection data and second collection data to the main server 300.

According to an embodiment, when the middleware server 200 is divided into a plurality of parts, the middleware server 200 may transfer each of the processed first collection data and second collection data to another part of the middleware server 200.

A method and apparatus according to the embodiments by the technical spirit of the present disclosure can effectively process collection data by autonomously selecting a data processing rule for processing collection data using data attribute information and communication terminal location attribute information.

Further, a method and apparatus according to the embodiments by the technical spirit of the present disclosure can select more optimized data processing rules by selecting data processing rules of first collection data collected from first communication terminals using an RFID communication method and second collection data collected from second communication terminals using a communication method other than RFID according to different criteria.

Further, a method and apparatus according to the embodiments by the technical spirit of the present disclosure can adaptively update a criterion for selecting a data processing rule through feedback of a main server to select a data processing rule optimized for a changing environment.

Although the present disclosure has been described in detail with reference to various embodiments, the present disclosure is not limited to the above embodiments, and may be changed and modified by those of ordinary skill in the art within the scope of the technical spirit of the present disclosure.

What is claimed is:

1. A middleware server, comprising:
a proxy unit for receiving first data attribute information, first communication terminal location attribute information, and first collection data from each of first communication terminals using an RFID communication method and receiving second data attribute information, second communication terminal location attribute information, and second collection data from each of second communication terminals using a communication method other than RFID;
a data processing rule selection module for selecting a data processing rule for processing the first collection data based on the received first data attribute information and first communication terminal location attribute information and selecting a data processing rule for processing the second collection data based on the received second data attribute information and second communication terminal location attribute information; and
a data processing module for processing each of the first collection data and the second collection data according to the selected data processing rules.

2. The middleware server of claim 1, wherein the proxy unit comprises:
a first proxy for receiving the first data attribute information, the first communication terminal location attribute information, and the first collection data from each of the first communication terminals; and
a second proxy for receiving the second data attribute information, the second communication terminal location attribute information, and the second collection data from each of the second communication terminals, separately from the first proxy.

3. The middleware server of claim 2, further comprising a security module for decoding the second data attribute information, the second communication terminal location attribute information, and the second collection data collected through the second proxy.

4. The middleware server of claim 3, wherein the data processing rule selection module selects a data processing rule of the first collection data and a data processing rule of the second collection data according to different criteria.

5. The middleware server of claim 4, further comprising a data processing rule updater for receiving processed results of data processed by the data processing module to be transmitted to the main server from the main server and updating the data processing rules according to the received processing result.

6. The middleware server of claim 5, wherein the data processing module comprises:
a data reception module for receiving the first collection data transmitted through the first proxy and the second collection data transmitted through the security module;
a log management module for recording and managing a log of the first collection data and the second collection data received by the data reception module; and
a data processing unit for receiving the first collection data and the second collection data transmitted through the data reception module and processing each of the received first collection data and second collection data according to the data processing rule transmitted from the data processing rule selection module.

7. The middleware server of claim 6, wherein the data processing unit comprises a data pattern analysis module for determining whether a particular data pattern is included in the first collection data or the second collection data.

8. The middleware server of claim 6, wherein the data processing unit comprises an input number counter for counting the number of times in which the first collection data or the second collection data is input during a reference time.

9. The middleware server of claim 4, wherein the data processing rule selection module comprises:
a processing rule selection module for selecting a plurality of data processing rules for processing the first data collection based on the received first data attribute information and first communication terminal location attribute information and selecting a plurality of data processing rules for processing the second collection data based on the received second data attribute information and second communication terminal location attribute information;
a processing rule priority determination module for determining an application priority of the selected data processing rules; and
a processing rule combination module for combining the selected data processing rules to transmit the combined data processing rules to the data processing module according to the determined priority.

10. A method of processing data of a middleware server, the method comprising:
receiving first data attribute information, first communication terminal location attribute information, and first collection data from each of first communication terminals using a RFID communication method;
receiving second data attribute information, second communication terminal location attribute information, and second collection data from each of second communication terminals using a communication method other than RFID;
selecting a data processing rule for processing the first collection data based on the received first data attribute information and first communication terminal location attribute information and selecting a data processing rule for processing the second collection data based on the received second data attribute information and second communication terminal location attribute information; and
processing each of the first collection data and the second collection data according to the selected data processing rules.
